(19) United States
(12) Patent Application Publication
(10) Pub. No.: US 2017/0064934 A1
(43) Pub. Date: Mar. 9, 2017

(54) SPINNING REEL

(71) Applicant: HAIBAO FISHING TACKLE CO., LTD., Cixi City (CN)

(72) Inventor: Wen-Hsiang Lee, Taichung City (TW)

(73) Assignee: HAIBAO FISHING TACKLE CO., LTD., Cixi City (CN)

(21) Appl. No.: 15/252,055

(22) Filed: Aug. 30, 2016

(30) Foreign Application Priority Data
Sep. 7, 2015 (CN) 201510562944.2

(51) Int. Cl. A01K 89/015

(52) U.S. Cl. CPC A01K 89/0184

(57) ABSTRACT

A spinning reel includes a main shaft, a crank for driving the main shaft to rotate, a spool shaft, a cam mechanism configured to translate rotation of the main shaft into linear reciprocating motion of the spool shaft, a tubular worm, a rotor coupled to the tubular worm to rotate therewith, a spool coupled to the spool shaft to move therewith, and a speed variation means which includes an output wheel for driving the tubular worm to rotate, a sun planetary gear system coupling the main shaft to the output wheel, and a coupler. The coupler is shiftable between a first position, where the output wheel and the main shaft are rotated at different speeds, and a second position, where the output wheel and the main shaft are rotated at the same speed.

### CROSS-REFERENCE TO RELATED APPLICATION

This application claims priority from Chinese patent application no. 201510562944.2, filed on Sep. 7, 2015.

### FIELD

The disclosure relates to a spinning reel, more particularly to a spinning reel with a speed variation means.

### BACKGROUND

A conventional spinning reel for fishing includes a reel body, a main shaft disposed inside the reel body, a hand-powered crank mounted rotatably on an outer surface of the rear body and configured to drive the main shaft to rotate about a first axis, a worm gear mounted on the main shaft to rotate therewith, a spool shaft extending along a second axis transverse to the first axis, a cam mechanism configured to translate rotation of the main shaft into linear reciprocating motion of the spool shaft along the second axis, a tubular worm sleeved on the spool shaft and configured to be driven by the worm gear to rotate about the second axis, a rotor coupled to the tubular worm to rotate therewith, and a spool coupled to the spool shaft to move therewith. The cam mechanism is disposed inside the reel body and includes a drive gear, a follower gear, a pin member, and a slider. The drive gear is mounted on the main shaft to rotate therewith about the first axis. The follower gear is rotatably mounted on an inner surface of the reel body and is configured to mesh with the drive gear to rotate about a third axis parallel to the first axis. The pin member is formed on the follower gear and is disposed radially offset from the third axis. The slider is mounted to the spool shaft to permit the spool shaft to move with the slider. The slider has an elongated groove which extends in a direction transverse to both the first and second axes, and which is configured to permit the pin member to be slidably engaged therein such that when the follower gear is driven to rotate with the drive gear, the slider, together with the spool and the spool shaft, is driven to linearly reciprocate along the second axis.

Another conventional spinning reel is disclosed in U.S. Pat. No. 7,537,178, and includes a reel unit, a rotation transmission mechanism, a handle assembly, a rotor, a spool shaft, an oscillating mechanism, and a spool. The reel unit includes a reel body that has a first opening, and a first lid member that covers the first opening. The rotation transmission mechanism includes a master gear shaft that is rotatably mounted to the reel unit, and a master gear that is disposed on the master gear shaft integrally rotatably about a first shaft axis. The reel body includes a first rotation support portion that rotatably supports the master gear shaft on a master gear side of the spool shaft. The first lid member includes a second rotation support portion that rotatably supports the master gear shaft on a first lid member side of the master gear.

Both of the conventional spinning reels do not include a speed variation means to accelerate or slow down rotational speed of the rotor in response to rotation of the main shaft or the master gear shaft.

### SUMMARY

Therefore, an object of the disclosure is to provide a novel spinning reel with a speed variation means including a sun planetary gear system.

According to a first aspect of the disclosure, a spinning reel includes a reel body, a drive unit mounted on the reel body, a rotor configured to be driven by the drive unit to rotate, a spool configured to be driven by the drive unit to linearly reciprocate relative to the rotor, and a speed variation means. The reel body is configured to receive therein the speed variation means. The drive unit includes a crank mounted rotatably on an outer surface of the reel body, a main shaft disposed inside the reel body and coupled to be driven by the crank to rotate about a first axis, a tubular worm extending along a second axis transverse to the first axis, and a spool shaft extending inside the tubular worm and coupled to be driven by the main shaft to linearly reciprocate. The speed variation means is sleeved on the main shaft, and includes an output wheel, a coupler, a sun planetary gear system, and an adjustment unit. The output wheel is configured to mesh with the tubular worm, and has a first engagement area and worm teeth configured to mesh with the tubular worm. The coupler is disposed at one side of the output wheel, and has a second engagement area. The sun planetary gear system is disposed between the output wheel and the coupler, and couples the main shaft to the output wheel so as to transmit rotational force of the main shaft to the output wheel. The adjustment unit is configured to drive the coupler to shift between a first position, where the coupler is engaged with the reel body to permit the output wheel and the main shaft to rotate at different speeds, and a second position, where the second engagement area of the coupler is in engagement with the first engagement area of the output wheel to permit the output wheel and the main shaft to rotate at the same speed.

According to a second aspect of the disclosure, a spinning reel includes a reel body, a main shaft, a hand-powered crank, a spool shaft, a cam mechanism, a tubular worm, a rotor, a spool, an output wheel, a sun planetary gear system, and a coupler. The reel body has a left shell and a right shell opposite to the left shell in a longitudinal direction. The left and right shells define therebetween an accommodation space. Each of the left and right shells has inner and outer surfaces. The left shell has an inner engagement area disposed on the inner surface thereof. The main shaft is disposed in the accommodation space, and extends along a first axis in the longitudinal direction. The main shaft has a left end segment, amid segment, and a right end segment which is rotatably mounted on the inner surface of the right shell. The hand-powered crank is configured to drive the main shaft to rotate about the first axis, and includes a rotating shaft and a crank arm. The rotating shaft is disposed in the accommodation space, and has a distal end coupled to the left end segment of the main shaft to permit the main shaft to rotate with the rotating shaft, and a proximate end extending outwardly of the left shell. The crank arm has a drive end, and a crank end which is opposite to the drive end, and which is coupled to the proximate end of the rotating shaft so as to permit a circular motion of the drive end to be translated into rotation of the rotating shaft about the first axis. The spool shaft extends along a second axis in a direction transverse to the longitudinal direction, and has a rear end segment disposed in the accommodation space, a middle segment, and a front end segment disposed forwardly of the reel body. The cam mechanism is disposed to couple the right end segment of the main shaft with the rear end segment of the spool shaft, and is configured to permit rotation of the main shaft to be translated into linear reciprocating motion of the spool shaft along the second axis. The tubular worm is rotatably sleeved on the middle segment of the spool shaft, and has a front end and a rear end opposite to the front end in the transverse direction. The rotor is disposed forwardly of the reel body, and is coupled to the front end of the tubular worm so as to be driven to rotate with the tubular worm about the second axis. The spool is disposed forwardly of the rotor, and is coupled to the front end segment of the spool shaft to move with the spool shaft. The output wheel is disposed in the accommodation space, and has a hub region, a left marginal region, and a right marginal region. The hub region is rotatably sleeved on the mid segment of the main shaft. The left marginal region has a left engagement area. The right marginal region is opposite to the left marginal region in the longitudinal direction, and is formed with worm teeth configured to mesh with the tubular worm so as to permit the tubular worm to rotate about the second axis when the output wheel is driven to rotate about the first axis. The sun planetary gear system is disposed in the accommodation space, and is configured to couple the main shaft to the output wheel such that the sun planetary gear system is set in a selected one of an enabling state, where the output wheel and the main shaft are rotated at different speeds, and a non-enabling state, where the output wheel and the main shaft are rotated at the same speed. The coupler is disposed between the sun planetary gear system and the left shell, and has an axial hole configured to permit the coupler to be rotatably sleeved on the mid segment of the main shaft. The coupler has a rightward engagement area and a leftward engagement area opposite to the rightward engagement area in the longitudinal direction. The coupler is shiftable between a leftward position, where the leftward engagement area is in splined engagement with the inner engagement area of the left shell so as to set the sun planetary gear system in the enabling state, and a rightward position, where the rightward engagement area is in splined engagement with the left engagement area of the output wheel so as to set the sun planetary gear system in the non-enabling state.

### BRIEF DESCRIPTION OF THE DRAWINGS

Other features and advantages of the disclosure will become apparent in the following detailed description of the embodiments with reference to the accompanying drawings, in which:

FIG. 1 is a perspective view of a spinning reel according to a first embodiment of the disclosure;

FIG. 2 is an exploded perspective view of the spinning reel of the first embodiment;

FIG. 3 is a cross-sectional view of the spinning reel shown in FIG. 1;

FIG. 4 is a cross-sectional view taken along line IV-IV of FIG. 3;

FIG. 5 is similar to FIG. 3 but illustrating a coupler in a rightward position;

FIG. 6 is an exploded perspective view of a portion of a spinning reel according to a second embodiment of the disclosure;

FIG. 7 is a cross-sectional view of the spinning reel of the second embodiment;

FIG. 8 is a cross-sectional view taken along line VIII-VIII of FIG. 7;

FIG. 9 is similar to FIG. 7 but illustrating a coupler in a rightward position;

FIG. 10 is an exploded perspective view of a portion of a spinning reel according to a third embodiment of the disclosure;

FIG. 11 is across-sectional view of the spinning reel of the third embodiment;

FIG. 12 is a cross-sectional view taken along line XII-XII of FIG. 11;

FIG. 13 is a cross-sectional view taken along line XIII-XIII of FIG. 11; and

FIG. 14 is similar to FIG. 11 but illustrating a coupler in a rightward position.

### DETAILED DESCRIPTION

Before the disclosure is described in greater detail, it should be noted that where considered appropriate, reference numerals have been repeated among the figures to indicate corresponding or analogous elements, which may optionally have similar characteristics.

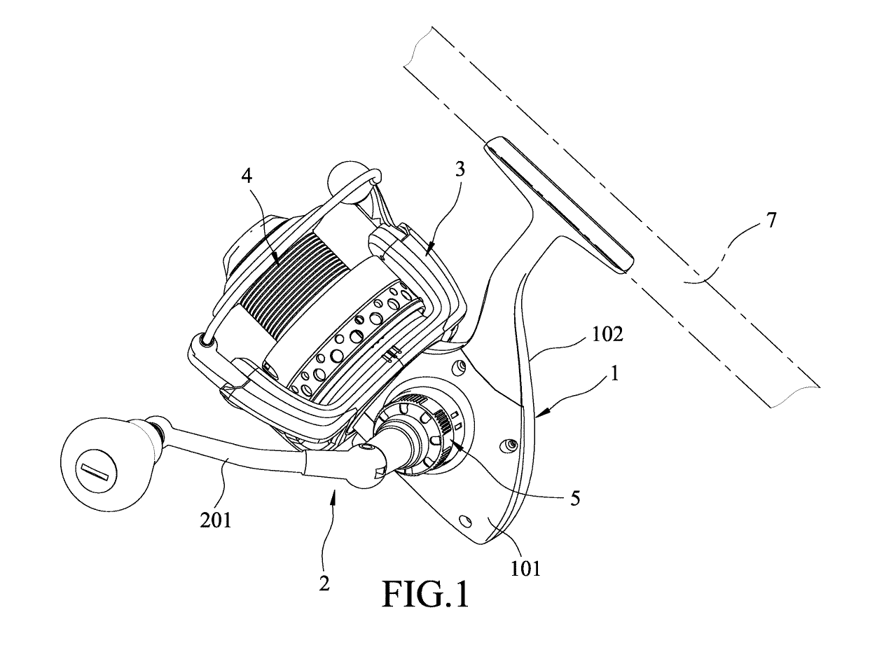

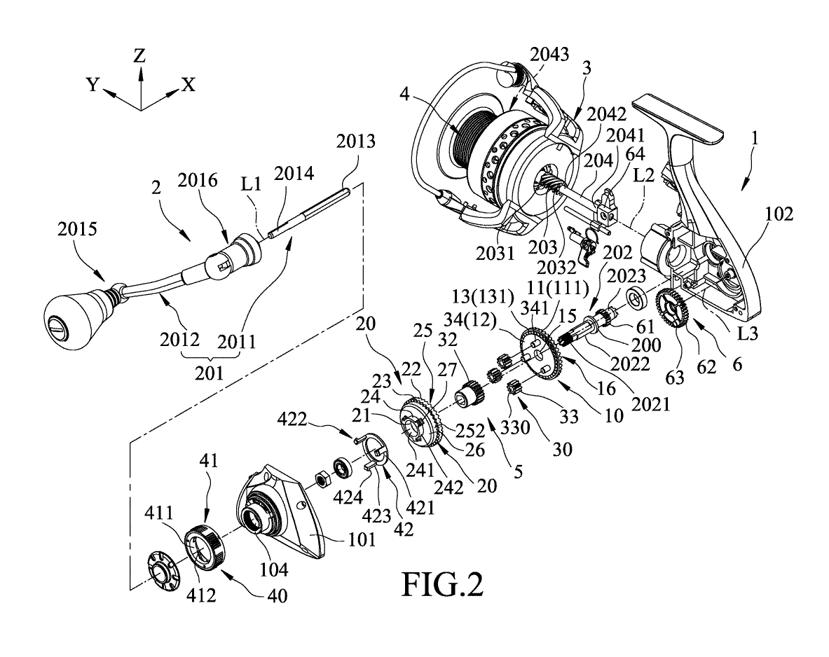

With reference to FIGS. 1 and 2, a spinning reel for fishing according to a first embodiment of the disclosure is shown to include a reel body 1, a drive unit 2, a rotor 3, a spool 4, and a speed variation means 5.

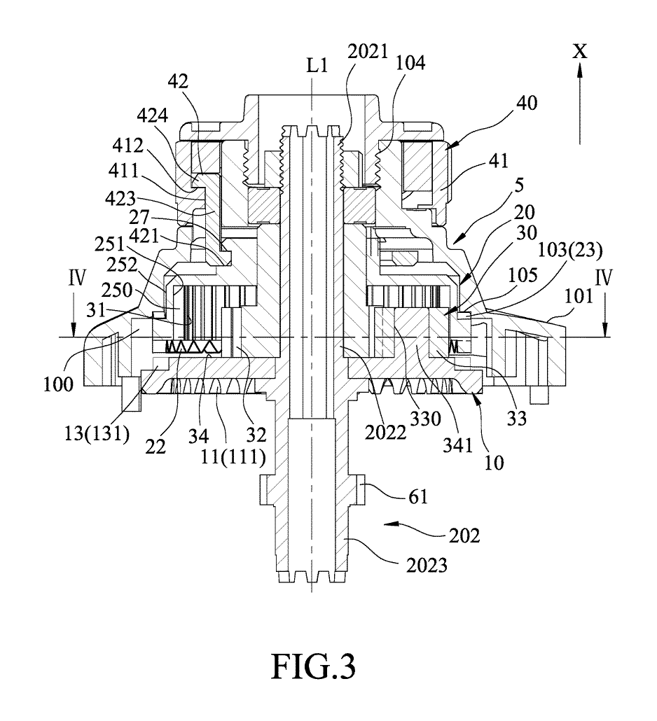

The reel body 1 is configured to be mounted on a fishing rod 7 or a boat gunwale (not shown), and has a left shell 101 and aright shell 102 opposite to the left shell 101 in a longitudinal direction (X). The left and right shells 101, 102 define therebetween an accommodation space 100 (see FIG. 3) for receiving the speed variation means 5. Each of the left and right shells 101, 102 has inner and outer surfaces. As shown in FIG. 3, the inner surface of the left shell 101 has a shoulder region 105 formed with an inner engagement area 103 which is of a sawtooth configuration. The shoulder region 105 extends in a circumferential direction about a first axis (L1) in the longitudinal direction (X).

In this embodiment, the left shell 101 has a tubular bore 104 which extends along the first axis (L1) through the inner and outer surfaces of the left shell 101.

As shown in FIG. 2, the drive unit 2 is mounted on the reel body 1, and includes a crank 201, a main shaft 202, a tubular worm 203, a spool shaft 204, and a cam mechanism 6.

The main shaft 202 is disposed in the accommodation space 100, and extends along the first axis (L1) in the longitudinal direction (X). The main shaft 202 has a left end segment 2021, a mid segment 2022, and a right end segment 2023 which is rotatably mounted on the inner surface of the right shell 102.

The crank 201 is mounted rotatably on the outer surface of the left shell 101 of the reel body 1 and is configured to drive the main shaft 202 to rotate about the first axis (L1). In this embodiment, the crank 201 is a hand-powered crank including a rotating shaft 2011 and a crank arm 2012.

The rotating shaft 2011 is disposed in the accommodation space 100 and extends through the tubular bore 104 of the left shell 101. The rotating shaft 2011 has a distal end 2013 and a proximate end 2014. The distal end 2013 is coupled to the left end segment 2021 of the main shaft 202 to permit the main shaft 202 to rotate with the rotating shaft 2011. The proximate end 2014 extends outwardly of the left shell 101.

The crank arm 2012 has a drive end 2015, and a crank end 2016 which is opposite to the drive end 2015, and which is coupled to the proximate end 2014 of the rotating shaft 2011 so as to permit a circular motion of the drive end 2015 to be translated into rotation of the rotating shaft 2011 about the first axis (L1).

The spool shaft 204 extends along a second axis (L2) in a direction (Y) transverse to the longitudinal direction (X), and has a rear end segment 2041 disposed in the accommodation space 100, a middle segment 2042, and a front end segment 2043 disposed forwardly of the reel body 1. In this embodiment, the second axis (L2) is perpendicular to the first axis (L1).

The cam mechanism 6 is disposed to couple the right end segment 2023 of the main shaft 202 with the rear end segment 2041 of the spool shaft 204, and is configured to permit rotation of the main shaft 202 to be translated into linear reciprocating motion of the spool shaft 204 along the second axis (L2).

In this embodiment, the cam mechanism 6 includes a drive gear 61, a follower gear 62, a pin member 63, and a slider 64. The drive gear 61 is mounted on the right end segment 2023 of the main shaft 202 to rotate with the main shaft 202 about the first axis (L1). The follower gear 62 is rotatably mounted on the inner surface of the right shell 102 and is configured to mesh with the drive gear 61 so as to be driven by the drive gear 61 to rotate about a third axis (L3) parallel to the first axis (L1). The pin member 63 is disposed on the follower gear 62 radially offset from the third axis (L3). The slider 64 is mounted on the rear end segment 2041 of the spool shaft 204 to permit the spool shaft 204 to move with the slider 64. The slider 64 has an elongated groove (not shown) which extends in a direction (Z) transverse to both the longitudinal and transverse directions (X, Y), and which is configured to permit the pin member 63 to be slidably engaged therein such that when the follower gear 62 is driven to rotate with the drive gear 61, the slider 64, together with the spool 4 and the spool shaft 204, is driven to linearly reciprocate along the second axis (L2).

The tubular worm 203 is rotatably sleeved on the middle segment 2042 of the spool shaft 204, and extends along the second axis (L2). The tubular worm 203 has a front end 2031 and a rear end 2032 opposite to the front end 2031 in the transverse direction (Y).

The rotor 3 is disposed forwardly of the reel body 1, and is coupled to the front end 2031 of the tubular worm 203 so as to be driven by the drive unit 2 to rotate with the tubular worm 203 about the second axis (L2).

The spool 4 is disposed forwardly of the rotor 3, and is coupled to the front end segment 2043 of the spool shaft 204 so as to move with the spool shaft 204.

The speed variation means 5 is sleeved on the main shaft 202, and includes an output wheel 10, a flange member 200, a coupler 20, a sun planetary gear system 30, and an adjustment unit 40.

The output wheel 10 is disposed in the accommodation space 100, and has a hub region 15, a rim segment 16, and a web region 12. The hub region 15 is rotatably sleeved on the mid segment 2022 of the main shaft 202. The rim segment 16 has a left marginal region 13 and a right marginal region 11 opposite to the left marginal region 13 in the longitudinal direction (X). The left marginal region 13 has a first engagement area (i.e., a left engagement area 131) which is of a sawtooth configuration. The right marginal region 11 is formed with worm teeth 111 configured to mesh with the tubular worm 203 so as to permit the tubular worm 203 to rotate about the second axis (L2) when the output wheel 10 is driven to rotate about the first axis (L1). The web region 12 is configured to span between the hub region 15 and the rim segment 16.

The flange member 200 extends radially from the mid segment 2022 of the main shaft 202, and is configured to position the output wheel 10.

The sun planetary gear system 30 is disposed in the accommodation space 100 to transmit rotational force of the main shaft 202 to the output wheel 10. The sun planetary gear system 30 is configured to couple the main shaft 202 to the output wheel 10 such that the sun planetary gear system 30 is set in a selected one of an enabling state, where the output wheel 10 and the main shaft 202 are rotated at different speeds, and a non-enabling state, where the output wheel 10 and the main shaft 202 are rotated at the same speed.

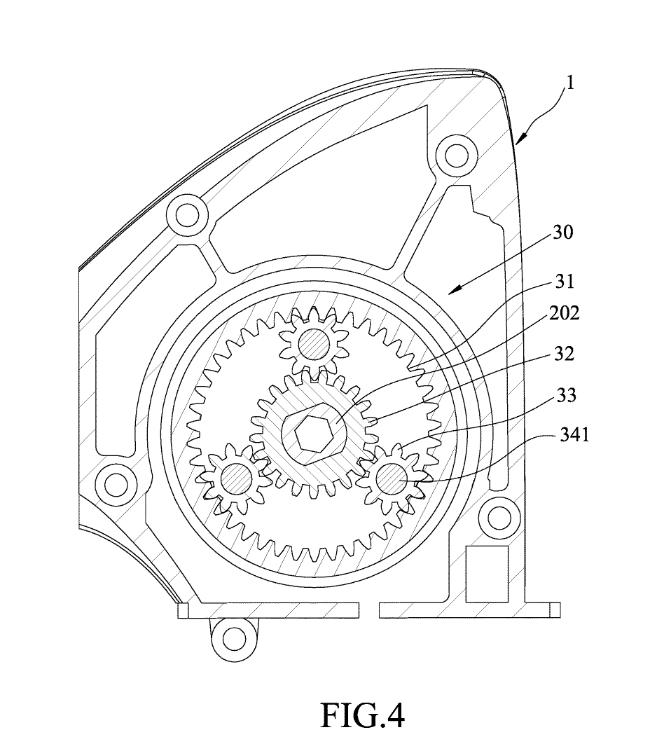

As shown in FIGS. 2, 3, and 4, the sun planetary gear system 30 includes a sun gear 32, a carrier web 34, a ring gear 31, and a plurality of planet gears 33.

The sun gear 32 is mounted on the main shaft 202 to rotate therewith about the first axis (L1).

The carrier web 34 is configured to span between the hub region 15 and the left marginal region 13 of the output wheel 10 to permit the output wheel 10 to rotate with the carrier web 34. In this embodiment, a left side of the web region 12 of the output wheel 10 serves as the carrier web 34, and the carrier web 34 has a plurality of carrier pins 341 formed on the left side of the web region 12.

As shown in FIG. 3, the ring gear 31 is mounted on an inner peripheral surface 251 of the coupler 20, and is configured to surround the sun gear 32.

The plurality of planet gears 33 are rotatably mounted on the carrier web 34, and are angularly displaced from each other about the first axis (L1). Each of the plurality of planet gears 33 is configured to mesh with both of the sun gear 32 and the ring gear 31. In this embodiment, the planet gears 33 each have a through hole 330 configured to permit the planet gears 33 to be rotatably and respectively sleeved on carrier pins 341 to permit the planet gears 33 to be rotatably mounted on the carrier web 34.

When the sun planetary gear system 30 is set in the enabling state, the sun planetary gear system 30 produces a decrease in a gear ratio,

$$R = \frac{1}{1 + ( \frac{{N}_{r}}{{N}_{s}} )}$$

where R is the gear ratio of the sun planetary gear system 30, Nᵣ is the number of teeth of the ring gear 31, and Nₛ is the number of teeth of the sun gear 32.

A ratio of rotation of the main shaft 202 to rotation of the output wheel 10 is 1/R, and the output wheel 10 is rotated at a slower speed than the main shaft 202 when the sun planetary gear system 30 is set in the enabling state.

The coupler 20 is disposed between the sun planetary gear system 30 and the left shell 101, and has an axial hole 21 configured to permit the coupler 20 to be rotatably sleeved on the mid segment 2022 of the main shaft 202. The coupler 20 has a second engagement area (i.e., a rightward engagement area 22) and a third engagement area (i.e., a leftward engagement area 23) opposite to the rightward engagement area 22 in the longitudinal direction (X). Both of the rightward and leftward engagement areas 22, 23 are of a sawtooth configuration. The coupler 20 is shiftable between a first position (i.e., a leftward position) and a second position (i.e., a rightward position).

In the leftward position, as shown in FIG. 3, the leftward engagement area 23 is in splined engagement with the inner engagement area 103 of the left shell 101 (i.e., the rightward engagement area 22 is disengaged from the left engagement area 131 of the output wheel 10) so as to set the sun planetary gear system 30 in the enabling state.

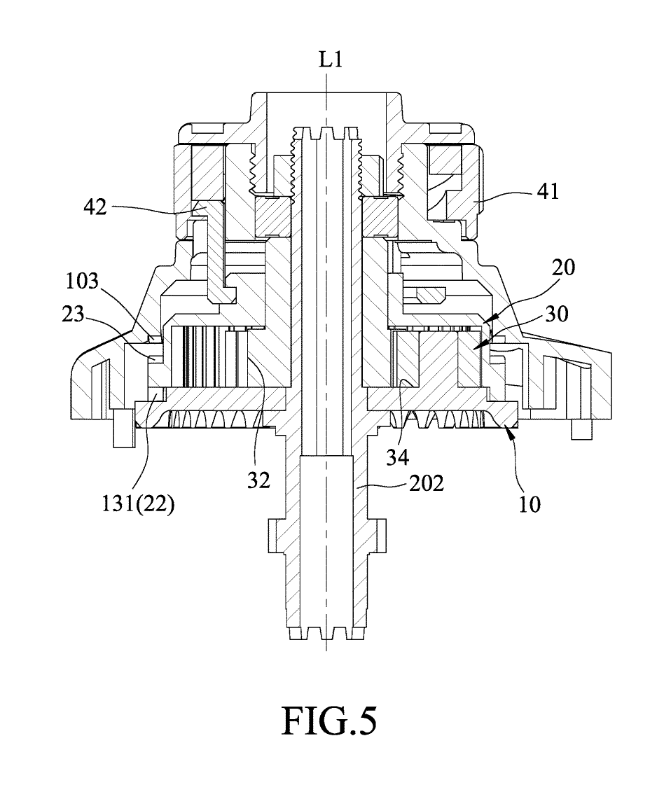

In the rightward position, as shown in FIG. 5, the rightward engagement area 22 is in splined engagement with the left engagement area 131 of the output wheel 10 (i.e., the leftward engagement area 23 is disengaged from the inner engagement area 103 of the left shell 101) so as to set the sun planetary gear system 30 in the non-enabling state.

As shown in FIG. 2, the coupler 20 has a small-diameter annular segment 24, a large-diameter annular segment 25, and a shoulder surface 26 defined between the small-diameter and large-diameter annular segments 24, 25.

The small-diameter annular segment 24 has an inner peripheral surface 241 defining the axial hole 21, and an outer peripheral surface 242 opposite to the inner peripheral surface 241 in radial directions.

The large-diameter annular segment 25 has an outer peripheral surface 252, and the inner peripheral surface 251 on which the ring gear 31 is mounted, as mentioned above. The inner and outer peripheral surfaces 251, 252 are opposite to each other in radial directions. The rightward and leftward engagement areas 22, 23 are formed on the outer peripheral surface 252. In addition, the inner peripheral surface 251 defines a space 250 for accommodation of the sun planetary gear system 30 so as to permit the rightward engagement area 22 of the coupler 20 to be brought into splined engagement with the left engagement area 131 of the output wheel 10.

The adjustment unit 40 is configured to drive the coupler 20 to shift between the leftward and rightward positions, and includes an annular cam member 41 and a cam follower 42.

The annular cam member 41 is disposed to be rotatable on the outer surface of the left shell 101 about the first axis (L1), and has an inner peripheral cam surface 411.

The cam follower 42 is configured to permit the coupler 20 to move therewith in the longitudinal direction (X), and has a connected end 421 and a follower end 422. The connected end 421 is disposed in the accommodation space 100 and is mounted to the coupler 20 to permit the coupler 20 to rotate relative to the cam follower 42. The follower end 422 is opposite to the connected end 421 in the longitudinal direction (X), and extends to permit the inner peripheral cam surface 411 to be slidably engaged with the follower end 422 to thereby allow the coupler 20 to be shifted between the leftward and rightward positions when the annular cam member 41 is driven to rotate about the first axis (L1).

In this embodiment, the connected end 421 of the cam follower 42 is in the form of a ring, and the outer peripheral surface 242 of the small-diameter annular segment 24 of the coupler 20 is configured to permit the ring 421 to anchor thereon, thereby allowing the coupler 20 to move with the cam follower 42 in the longitudinal direction (X). As shown in FIG. 2, a plurality of hook members 27 are formed on the outer peripheral surface 242 for anchoring the ring 421.

In this embodiment, the cam follower 42 has a plurality of legs 423 which are displaced from each other in a circumferential direction about the first axis (L1), and which respectively extend from the ring 421 in the longitudinal direction (X) to terminate at a plurality of leg ends 424 serving as the follower end 422.

In this embodiment, the inner peripheral cam surface 411 of the annular cam member 41 is formed with a plurality of camming grooves 412. Each of the camming grooves 412 extends in the circumferential direction about the first axis (L1), and is configured to slidably engage a corresponding one of the leg ends 424 of the legs 423.

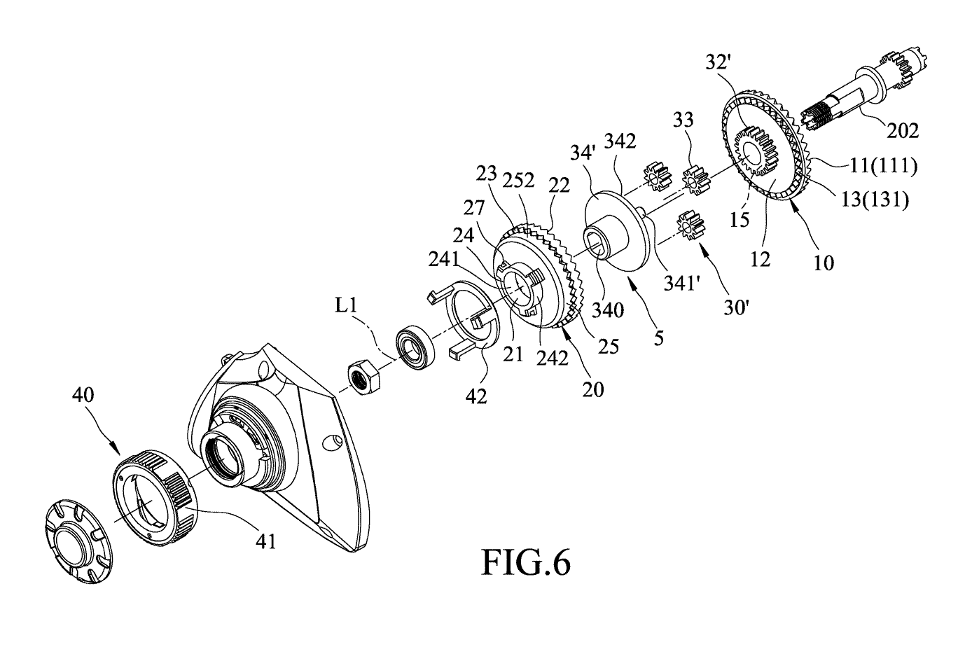

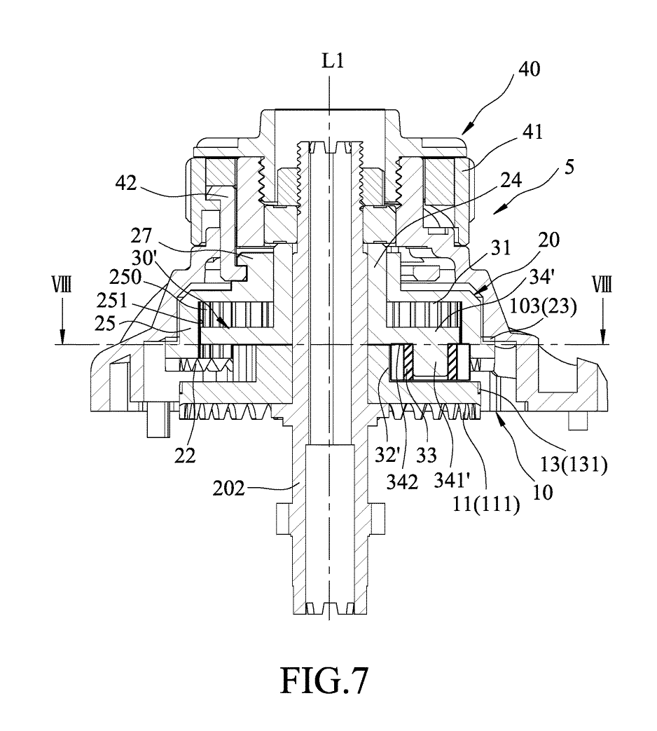

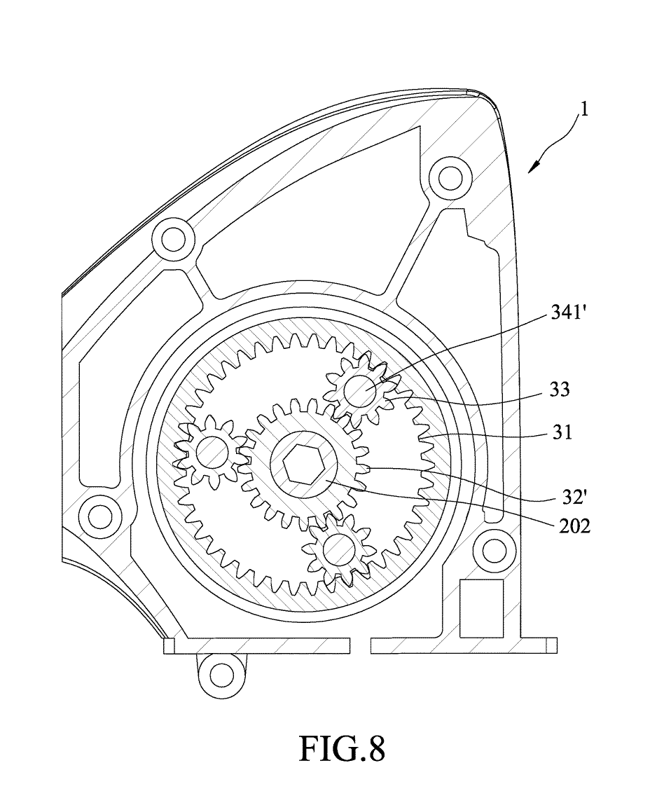

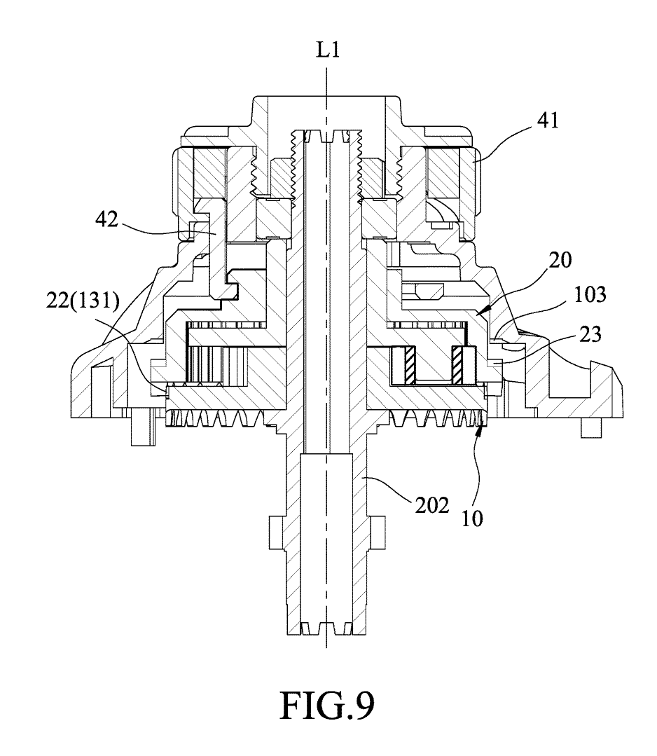

FIGS. 6 to 9 illustrate a spinning reel according to a second embodiment of the disclosure. FIG. 7 illustrates the coupler 20 in the leftward position, and FIG. 9 illustrates the coupler 20 in the rightward position. The second embodiment is similar to the first embodiment except that in the second embodiment, a sun planetary gear system 30′ is provided instead of the sun planetary gear system 30.

The sun planetary gear system 30′ is disposed in the accommodation space 100 to transmit rotational force of the main shaft 202 to the output wheel 10. The sun planetary gear system 30′ is configured to couple the main shaft 202 to the output wheel 10 such that the sun planetary gear system 30′ is set in a selected one of an enabling state, where the output wheel 10 and the main shaft 202 are rotated at different speeds, and a non-enabling state, where the output wheel 10 and the main shaft 202 are rotated at the same speed.

The sun planetary gear system 30′ includes a sun gear 32′, a carrier member 34′, a ring gear 31, and a plurality of planet gears 33.

The sun gear 32′ is mounted on the hub region 15 of the output wheel 10 to permit the output wheel 10 to rotate therewith.

The carrier member 34′ has a through hole 340 configured to permit the carrier member 34′ to be sleeved on and to rotate with the main shaft 202. The carrier member 34′ has a right surface 342 facing toward the output wheel 10, and a plurality of carrier pins 341′ are formed on the right surface 342 of the carrier member 34′.

The ring gear 31 is mounted on the inner peripheral surface 251 of the large-diameter annular segment 25 of the coupler 20, and is configured to surround the sun gear 32′.

The plurality of planet gears 33 are rotatably mounted on the carrier member 34′, and are angularly displaced from each other about the first axis (L1). Each of the plurality of planet gears 33 is configured to mesh with both of the sun gear 32′ and the ring gear 31. Furthermore, the planet gears 33 each have a through hole 330 configured to permit the planet gears 33 to be rotatably and respectively sleeved on the carrier pins 341′ such that the planet gears 33 are rotatably mounted on the carrier web 34′.

When the sun planetary gear system 30′ is set in the enabling state, the sun planetary gear system 30′ produces an increase in a gear ratio,

$$R = 1 + ( \frac{{N}_{r}}{{N}_{s}} )$$

where R is the gear ratio of the sun planetary gear system 30′, Nᵣ is the number of teeth of the ring gear 31, and Nₛ is the number of teeth of the sun gear 32′.

A ratio of rotation of the main shaft 202 to rotation of the output wheel 10 is 1/R, and the output wheel 10 is rotated at a faster speed than the main shaft 202 when the sun planetary gear system 30′ is set in the enabling state.

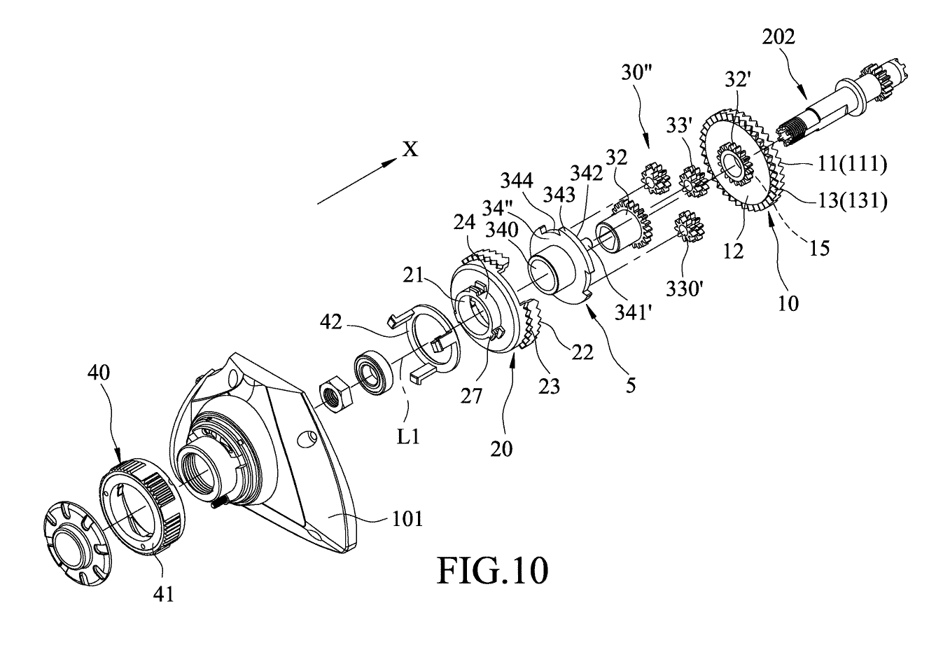

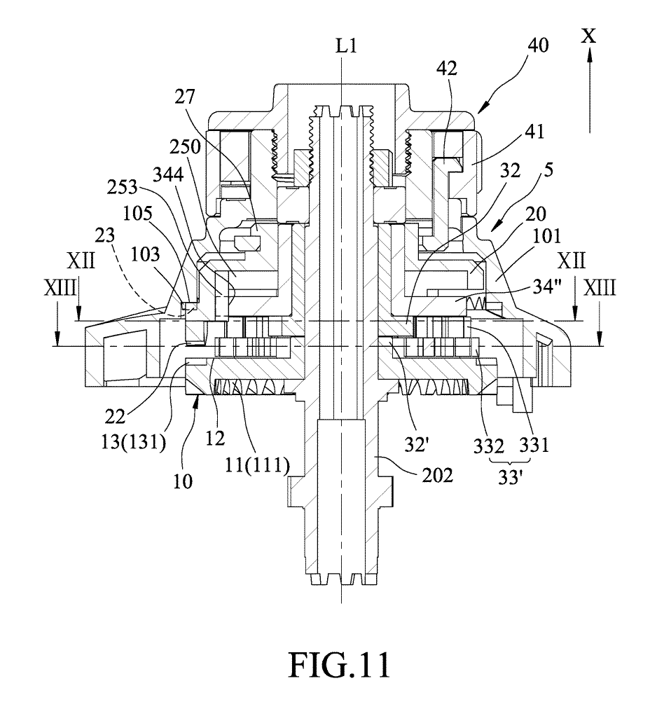

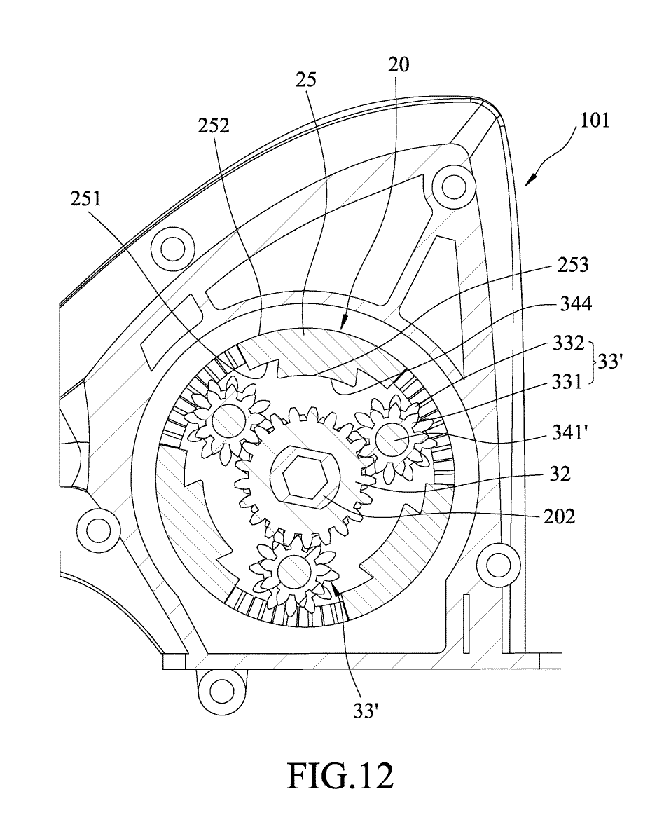

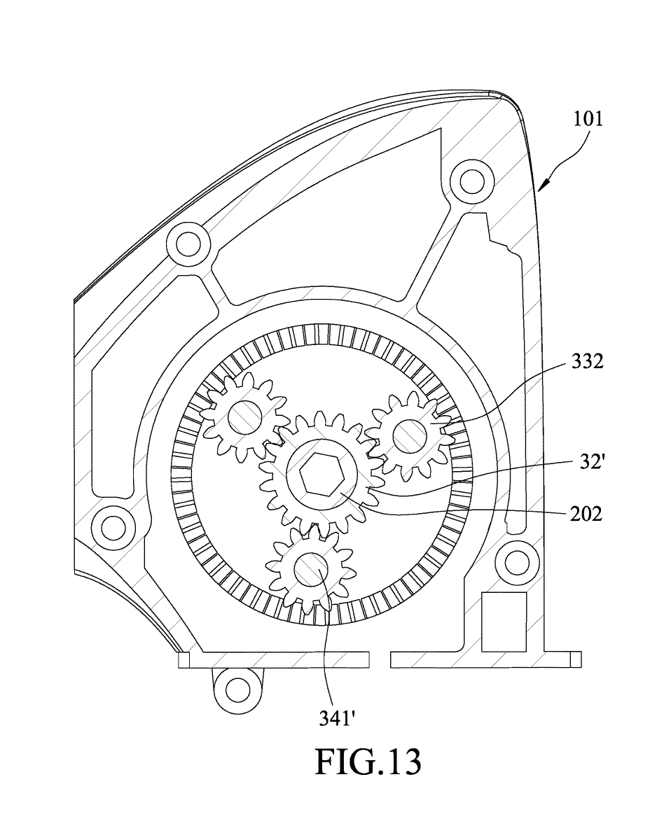

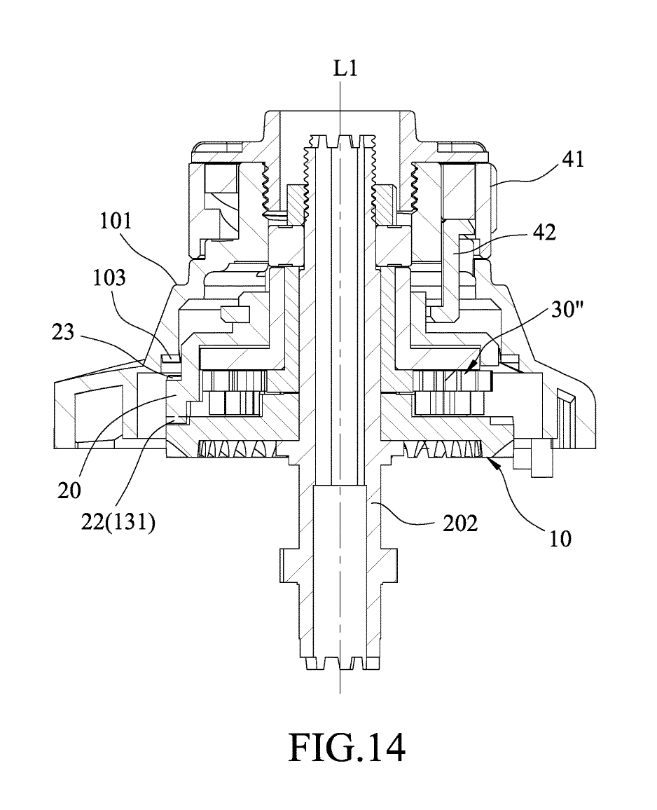

FIGS. 10 to 14 illustrate a spinning reel according to a third embodiment of the disclosure. FIG. 11 illustrates the coupler 20 in the leftward position, and FIG. 14 illustrates the coupler 20 in the rightward position. The third embodiment is similar to the second embodiment except that in the second embodiment, a sun planetary gear system 30″ is provided instead of the sun planetary gear system 30′. In addition, the inner peripheral surface 251 of the large-diameter annular segment 25 of the coupler 20 is formed with a plurality of key regions 253 which respectively extend in the longitudinal direction (X), and which are angularly displaced from each other about the first axis (L1).

The sun planetary gear system 30″ is disposed in the accommodation space 100 to transmit rotational force of the main shaft 202 to the output wheel 10. The sun planetary gear system 30″ is configured to couple the main shaft 202 to the output wheel 10 such that the sun planetary gear system 30″ is set in a selected one of an enabling state, where the output wheel 10 and the main shaft 202 are rotated at different speeds, and a non-enabling state, where the output wheel 10 and the main shaft 202 are rotated at the same speed.

The sun planetary gear system 30″ includes a carrier member 34″, a first sun gear 32, a second sun gear 32′, and a plurality of stepped-planet gears 33′.

The carrier member 34″ has a through hole 340, a plurality of carrier pins 341′, a right surface 342 facing toward the output wheel 10, a marginal edge 343, and a plurality of key slots 344. The through hole 340 is configured to permit the carrier member 34″ to be sleeved on the main shaft 202. The plurality of carrier pins 341′ are formed on the right surface 342. Each of the plurality of key slots 344 extends from the marginal edge 343 toward the first axis (L). The plurality of key slots 344 are angularly displaced from each other about the first axis (L1), and are configured to permit the key regions 253 to be matingly engaged in the key slots 344, respectively, such that the coupler 20 is shiftably engaged with the carrier member 34″ in the longitudinal direction (X), and such that the carrier member 34″ is prevented from rotation with respect to the coupler 20.

The first sun gear 32 is mounted on the main shaft 202 to rotate therewith about the first axis (L1).

The second sun gear 32′ is mounted on the hub region 15 of the output wheel 10 to permit the output wheel 10 to rotate therewith.

The plurality of stepped-planet gears 33′ are rotatably mounted on the carrier member 34″, and are angularly displaced from each other about the first axis (L1). Each of the stepped-planet gears 33′ includes a first stepped gear 331 meshed with the first sun gear 32, and a second stepped gear 332 meshed with the second sun gear 32′. Furthermore, the stepped-planet gears 33′ each have a through hole 330′ configured to permit the stepped-planet gears 33′ to be rotatably and respectively sleeved on the carrier pins 341′ to permit the stepped-planet gears 33′ to be rotatably mounted on the carrier web 34″.

When the sun planetary gear system 30″ is set in the enabling state, the sun planetary gear system 30″ produces an increase or a decrease in a gear ratio,

$$R = \frac{\frac{{N}_{s 1}}{{N}_{p 1}}}{\frac{{N}_{s 2}}{{N}_{p 2}}}$$

where R is the gear ratio of the sun planetary gear system 30″, Nₛ₁ is the number of teeth of the first sun gear 32, Nₛ₂ is the number of teeth of the second sun gear 32′, Nₚ₁ is the number of teeth of the first stepped gear 331, and Nₚ₂ is the number of teeth of the second stepped gear 332.

A ratio of rotation of the main shaft 202 to rotation of the output wheel 10 is 1/R, and the output wheel 10 is rotated at a faster or slower speed than the main shaft 202 when the sun planetary gear system 30′ is set in the enabling state.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A spinning reel for fishing, comprising a reel body, a drive unit mounted on said reel body, a rotor configured to be driven by said drive unit to rotate, a spool configured to be driven by said drive unit to linearly reciprocate relative to said rotor, and a speed variation means, said reel body being configured to receive therein said speed variation means, said drive unit including a crank mounted rotatably on an outer surface of said reel body, a main shaft disposed inside said reel body and coupled to be driven by said crank to rotate about a first axis, a tubular worm extending along a second axis transverse to the first axis, and a spool shaft extending inside said tubular worm and coupled to be driven by said main shaft to linearly reciprocate, said speed variation means being sleeved on said main shaft, and including
an output wheel configured to mesh with said tubular worm, and having a first engagement area, and worm teeth configured to mesh with said tubular worm,
a coupler disposed at one side of said output wheel, and having a second engagement area,
a sun planetary gear system which is disposed between said output wheel and said coupler, and which couples said main shaft to said output wheel so as to transmit rotational force of said main shaft to said output wheel, and
an adjustment unit configured to drive said coupler to shift between a first position, where said coupler is engaged with said reel body to permit said output wheel and said main shaft to rotate at different speeds, and a second position, where said second engagement area of said coupler is in engagement with said first engagement area of said output wheel to permit said output wheel and said main shaft to rotate at the same speed.

2. The spinning reel according to claim 1, wherein:
a reel body has a left shell and a right shell opposite to said left shell in a longitudinal direction, said left and right shells defining therebetween an accommodation space, each of said left and right shells having inner and outer surfaces, said left shell having an inner engagement area disposed on said inner surface thereof;
said main shaft is disposed in said accommodation space, and extends along the first axis in the longitudinal direction, said main shaft having a left end segment, amid segment, and a right end segment which is rotatably mounted on said inner surface of said right shell; and
said crank is a hand-powered crank including
a rotating shaft disposed in said accommodation space, and having a distal end coupled to said left end segment of said main shaft to permit said main shaft to rotate therewith, and a proximate end extending outwardly of said left shell, and
a crank arm having a drive end, and a crank end which is opposite to said drive end, and which is coupled to said proximate end of said rotating shaft so as to permit a circular motion of said drive end to be translated into rotation of said rotating shaft about the first axis;
said output wheel is disposed in said accommodation space, and has
a hub region rotatably sleeved on said mid segment of said main shaft,
a left marginal region having said first engagement area, and
a right marginal region which is opposite to said left marginal region in the longitudinal direction, and which is formed with said worm teeth so as to permit said tubular worm to rotate about the second axis when said output wheel is driven to rotate about the first axis;
said sun planetary gear system is disposed in said accommodation space, and is configured such that said sun planetary gear system is set in a selected one of an enabling state, where said output wheel and said main shaft are rotated at different speeds, and a non-enabling state, where said output wheel and said main shaft are rotated at the same speed; and
said coupler is disposed between said sun planetary gear system and said left shell, and has an axial hole configured to permit said coupler to be rotatably sleeved on said mid segment of said main shaft, said coupler having said second engagement area and a third engagement area opposite to said second engagement area in the longitudinal direction, said second engagement area being configured to be in splined engagement with said first engagement area of said output wheel so as to set said sun planetary gear system in the non-enabling state, said third engagement area being configured to be in splined engagement with said inner engagement area of said left shell so as to set said sun planetary gear system in the enabling state.

3. The spinning reel according to claim 2, wherein:
said spool shaft extends along the second axis in a direction transverse to the longitudinal direction, and has a rear end segment disposed in said accommodation space, a middle segment, and a front end segment disposed forwardly of said reel body;
said tubular worm is rotatably sleeved on said middle segment of said spool shaft, and has a front end and a rear end opposite to said front end in the transverse direction;
said rotor is disposed forwardly of said reel body, and is coupled to said front end of said tubular worm so as to be driven to rotate with said tubular worm about the second axis; and
said spool is disposed forwardly of said rotor, and is coupled to said front end segment of said spool shaft to move therewith,
said spinning reel further comprising
a cam mechanism which is disposed to couple said right end segment of said main shaft with said rear end segment of said spool shaft, and which is configured to permit rotation of said main shaft to be translated into linear reciprocating motion of said spool shaft along the second axis.

4. The spinning reel according to claim 2, wherein said left shell has a tubular bore which extends along the first axis through said inner and outer surfaces of said left shell, and which is configured for extension of said rotating shaft, said adjustment unit includes
an annular cam member disposed to be rotatable on said outer surface of said left shell about the first axis, and having an inner peripheral cam surface, and
a cam follower which is configured to permit said coupler to move therewith in the longitudinal direction, and which has
a connected end which is disposed in said accommodation space and which is mounted to said coupler to permit said coupler to rotate relative to said cam follower, and
a follower end which is opposite to said connected end in the longitudinal direction, and which extends to permit said inner peripheral cam surface to be slidably engaged with said follower end to thereby allow said coupler to be shifted between the first and second positions when said annular cam member is driven to rotate about the first axis.

5. The spinning reel according to claim 4, wherein said connected end of said cam follower is in the form of a ring, and said coupler has
a small-diameter annular segment having an inner peripheral surface defining said axial hole, and an outer peripheral surface configured to permit said ring to anchor thereon, thereby allowing said coupler to move with said cam follower in the longitudinal direction, and
a large-diameter annular segment having an outer peripheral surface on which said second and third engagement areas are formed, and an inner peripheral surface which defines a space for accommodation of said sun planetary gear system so as to permit said second engagement area of said coupler to be brought into splined engagement with said first engagement area of said output wheel.

6. The spinning reel according to claim 5, wherein:
said cam follower has a plurality of legs which are displaced from each other in a circumferential direction about the first axis, and which respectively extend from said ring in the longitudinal direction to terminate at a plurality of leg ends serving as said follower end; and
said inner peripheral cam surface of said annular cam member is formed with a plurality of camming grooves each extending in the circumferential direction about the first axis, and each being configured to slidably engage a corresponding one of said leg ends of said legs.

7. The spinning reel according to claim 5, wherein said sun planetary gear system includes
a sun gear mounted on said main shaft to rotate therewith about the first axis,
a carrier web configured to span between said hub region and said left marginal region of said output wheel to permit said output wheel to rotate with said carrier web,
a ring gear which is mounted on said inner peripheral surface of said large-diameter annular segment, and which is configured to surround said sun gear, and
a plurality of planet gears which are rotatably mounted on said carrier web, and which are angularly displaced from each other about the first axis, each of said plurality of planet gears being configured to mesh with both of said sun gear and said ring gear.

8. The spinning reel according to claim 5, wherein said sun planetary gear system includes
a sun gear mounted on said hub region of said output wheel to permit said output wheel to rotate therewith,
a carrier member having a through hole configured to permit said carrier member to be sleeved on and to rotate with said main shaft,
a ring gear which is mounted on said inner peripheral surface of said large-diameter annular segment, and which is configured to surround said sun gear, and
a plurality of planet gears which are rotatably mounted on said carrier member, and which are angularly displaced from each other about the first axis, each of said plurality of planet gears being configured to mesh with both of said sun gear and said ring gear.

9. The spinning reel according to claim 5, wherein said inner peripheral surface of said large-diameter annular segment of said coupler is formed with a plurality of key regions which respectively extend in the longitudinal direction, and which are angularly displaced from each other about the first axis,
said sun planetary gear system including
a carrier member having a through hole configured to permit said carrier member to be sleeved on said main shaft, and a plurality of key slots which are angularly displaced from each other about the first axis, and which are configured to permit said key regions to be matingly engaged in said key slots, respectively, such that said coupler is shiftably engaged with said carrier member in the longitudinal direction, and such that said carrier member is prevented from rotation with respect to said coupler,
a first sun gear mounted on said main shaft to rotate therewith about the first axis,
a second sun gear mounted on said hub region of said output wheel to permit said output wheel to rotate therewith, and
a plurality of stepped-planet gears which are rotatably mounted on said carrier member, and which are angularly displaced from each other about the first axis, each of said stepped-planet gears including a first stepped gear meshed with said first sun gear, and a second stepped gear meshed with said second sun gear.

10. A spinning reel for fishing, comprising:
a reel body having a left shell and a right shell opposite to said left shell in a longitudinal direction, said left and right shells defining therebetween an accommodation space, each of said left and right shells having inner and outer surfaces, said left shell having an inner engagement area disposed on said inner surface thereof;
a main shaft disposed in said accommodation space, and extending along a first axis in the longitudinal direction, said main shaft having a left end segment, a mid segment, and a right end segment which is rotatably mounted on said inner surface of said right shell;
a hand-powered crank configured to drive said main shaft to rotate about the first axis, and including
a rotating shaft disposed in said accommodation space, and having a distal end coupled to said left end segment of said main shaft to permit said main shaft to rotate with said rotating shaft, and a proximate end extending outwardly of said left shell, and
a crank arm having a drive end, and a crank end which is opposite to said drive end, and which is coupled to said proximate end of said rotating shaft so as to permit a circular motion of said drive end to be translated into rotation of said rotating shaft about the first axis;
a spool shaft extending along a second axis in a direction transverse to the longitudinal direction, and having a rear end segment disposed in said accommodation space, a middle segment, and a front end segment disposed forwardly of said reel body;
a cam mechanism which is disposed to couple said right end segment of said main shaft with said rear end segment of said spool shaft, and which is configured to permit rotation of said main shaft to be translated into linear reciprocating motion of said spool shaft along the second axis;
a tubular worm which is rotatably sleeved on said middle segment of said spool shaft, and which has a front end and a rear end opposite to said front end in the transverse direction;
a rotor disposed forwardly of said reel body, and coupled to said front end of said tubular worm so as to be driven to rotate with said tubular worm about the second axis;
a spool disposed forwardly of said rotor, and coupled to said front end segment of said spool shaft to move with said spool shaft;
an output wheel disposed in said accommodation space, and having
a hub region rotatably sleeved on said mid segment of said main shaft,
a left marginal region having a left engagement area, and
a right marginal region which is opposite to said left marginal region in the longitudinal direction, and which is formed with worm teeth configured to mesh with said tubular worm so as to permit said tubular worm to rotate about the second axis when said output wheel is driven to rotate about the first axis;
a sun planetary gear system which is disposed in said accommodation space, and which is configured to couple said main shaft to said output wheel such that said sun planetary gear system is set in a selected one of an enabling state, where said output wheel and said main shaft are rotated at different speeds, and a non-enabling state, where said output wheel and said main shaft are rotated at the same speed; and
a coupler disposed between said sun planetary gear system and said left shell, and having an axial hole configured to permit said coupler to be rotatably sleeved on said mid segment of said main shaft, said coupler having a rightward engagement area and a leftward engagement area opposite to said rightward engagement area in the longitudinal direction, said coupler being shiftable between a leftward position, where said leftward engagement area is in splined engagement with said inner engagement area of said left shell so as to set said sun planetary gear system in the enabling state, and a rightward position, where said rightward engagement area is in splined engagement with said left engagement area of said output wheel so as to set said sun planetary gear system in the non-enabling state.

11. The spinning reel according to claim 10, further comprising a flange member which extends radially from said mid segment of said main shaft, and which is configured to position said output wheel.

12. The spinning reel according to claim 10, wherein said left shell has a tubular bore which extends along the first axis through said inner and outer surfaces of said left shell, and which is configured for extension of said rotating shaft,
said spinning reel further comprising
an annular cam member disposed to be rotatable on said outer surface of said left shell about the first axis, and having an inner peripheral cam surface, and
a cam follower which is configured to permit said coupler to move therewith in the longitudinal direction, and which has
a connected end which is disposed in said accommodation space and which is mounted to said coupler to permit said coupler to rotate relative to said cam follower, and
a follower end which is opposite to said connected end in the longitudinal direction, and which extends to permit said inner peripheral cam surface to be slidably engaged with said follower end to thereby allow said coupler to be shifted between the leftward and rightward positions when said annular cam member is driven to rotate about the first axis.

13. The spinning reel according to claim 12, wherein said connected end of said cam follower is in the form of a ring, and said coupler has
a small-diameter annular segment having an inner peripheral surface defining said axial hole, and an outer peripheral surface configured to permit said ring to anchor thereon, thereby allowing said coupler to move with said cam follower in the longitudinal direction, and
a large-diameter annular segment having an outer peripheral surface on which said rightward and leftward engagement areas are formed, and an inner peripheral surface which defines a space for accommodation of said sun planetary gear system so as to permit said rightward engagement area of said coupler to be brought into splined engagement with said left engagement area of said output wheel.

14. The spinning reel according to claim 13, wherein:
said cam follower has a plurality of legs which are displaced from each other in a circumferential direction about the first axis, and which respectively extend from said ring in the longitudinal direction to terminate at a plurality of leg ends serving as said follower end; and
said inner peripheral cam surface of said annular cam member is formed with a plurality of camming grooves each extending in the circumferential direction about the first axis, and each being configured to slidably engage a corresponding one of said leg ends of said legs.

15. The spinning reel according to claim 13, wherein said sun planetary gear system includes
a sun gear mounted on said main shaft to rotate therewith about the first axis,
a carrier web configured to span between said hub region and said left marginal region of said output wheel to permit said output wheel to rotate with said carrier web,
a ring gear which is mounted on said inner peripheral surface of said large-diameter annular segment, and which is configured to surround said sun gear, and
a plurality of planet gears which are rotatably mounted on said carrier web, and which are angularly displaced from each other about the first axis, each of said plurality of planet gears being configured to mesh with both of said sun gear and said ring gear.

16. The spinning reel according to claim 13, wherein said sun planetary gear system includes
a sun gear mounted on said hub region of said output wheel to permit said output wheel to rotate therewith,
a carrier member having a through hole configured to permit said carrier member to be sleeved on and to rotate with said main shaft,
a ring gear which is mounted on said inner peripheral surface of said large-diameter annular segment, and which is configured to surround said sun gear, and
a plurality of planet gears which are rotatably mounted on said carrier member, and which are angularly displaced from each other about the first axis, each of said plurality of planet gears being configured to mesh with both of said sun gear and said ring gear.

17. The spinning reel according to claim 13, wherein said inner peripheral surface of said large-diameter annular segment of said coupler is formed with a plurality of key regions which respectively extend in the longitudinal direction, and which are angularly displaced from each other about the first axis,
said sun planetary gear system including
a carrier member having a through hole configured to permit said carrier member to be sleeved on said main shaft, and a plurality of key slots which are angularly displaced from each other about the first axis, and which are configured to permit said key regions to be matingly engaged in said key slots, respectively, such that said coupler is shiftably engaged with said carrier member in the longitudinal direction, and such that said carrier member is prevented from rotation with respect to said coupler,
a first sun gear mounted on said main shaft to rotate therewith about the first axis,
a second sun gear mounted on said hub region of said output wheel to permit said output wheel to rotate therewith, and
a plurality of stepped-planet gears which are rotatably mounted on said carrier member, and which are angularly displaced from each other about the first axis, each of said stepped-planet gears including a first stepped gear meshed with said first sun gear, and a second stepped gear meshed with said second sun gear.
